(19) United States
(12) Patent Application Publication
(10) Pub. No.: US 2026/0266707 A1
(43) Pub. Date: Sep. 10, 2026

(54) Classification Of Particles By Means Of Spectral Analysis

(71) Applicant: Wagner Group GmbH, Langenhagen (DE)

(72) Inventors: Daniel Filippini, Wedemark (DE); Jonas Hartwig, Langenhagen (DE)

(21) Appl. No.: 19/127,622

(22) PCT Filed: Nov. 21, 2023
(86) PCT No.: PCT/EP2023/082487

§ 371 Date: May 13, 2026

(30) Foreign Application Priority Data
Nov. 22, 2022 (EP) 22208824.7
May 2, 2023 (EP) 23170973.4

(51) Int. Cl. G01N 15/0205; G01N 15/00; G01N 15/075; G08B 17/107

(52) U.S. Cl. CPC G01N 15/0211; G01N 15/075; G01N 2015/0046; G08B 17/107

(57) ABSTRACT

A method for classifying particles detected by means of a particle detection unit (200), which comprises a light transmitter (210) and a light receiver (220) for detecting at least a portion of the emitted light, and are oriented with respect to one another so as to define a detection region (DB). Particles detected within the detection region (DB) are classified by means of spectral analysis, wherein—at least a first light intensity signal (I₁) and a second light intensity signal (I₂) are measured. A reference light intensity signal (I₀), is measured, that has a characteristic reference wavelength (λ₀). The at least first and second light intensity signals (I₁, I₂) are each set in relation to the reference light intensity signal (I₀). The thus obtained relation values (I₁/I₀, I₂/I₀) are ranked in a classification map (130), and the detected particles are allocated to a defined particle class (S₁, S₂, S₃).

### BACKGROUND OF THE INVENTION

### (1) Field of the Invention

The invention relates to a method for classifying particles detected by means of a particle detection unit, which particle detection unit comprises a light transmitter for emitting light and a light receiver for detecting at least a portion of the emitted light, in particular a scattered light and/or transmitted light component.

The invention also relates to a particle detection unit which is suitable for carrying out the classification method, comprising a light transmitter for emitting light and a light receiver for detecting at least a portion of the emitted light, in particular a scattered light and/or transmitted light component, as well as a control module which is connected to the light transmitter and the light receiver in a signal-transmitting manner. The light transmitter and the light receiver are oriented to each other to define a detection region, and the control module is configured to detect particles located within the detection region based on the light detected by the light receiver.

### (2) Description of the Related Art

Such particle detection units are often used for fire detection, especially in buildings, vehicles, on ships, etc. This involves detecting particles contained in the ambient air of a monitoring region, e.g. smoke particles or aerosols that indicate a fire or its origin are detected by the particle detection unit. A momitoring region is usually a region to be monitored in which people are present, (valuable) goods are stored and/or there is an increased risk of fire. Monitoring regions can be parts of a building, such as rooms, storage rooms or server rooms, parts of a vehicle, e.g. a ship, train, bus or aircraft, such as passenger compartments or engine rooms, but also an region in the immediate vicinity or within an object, such as a machine or a control cabinet. A well-known application is the so-called ceiling smoke detector, also called a point-type smoke detector, which is mounted, for example, on the ceiling of a room or room in a building. The interior of the housing, i.e. the detection chamber of the ceiling smoke detector, is fluidically connected to the ambient air. The detection region is defined by superimposing the light path of the light transmitter and the incidence region of the light receiver within the detection chamber. Particles located in the detection region are illuminated by the light emitted by the light transmitter and can be detected by the light receiver either by the transmitted light reduced by the particles (transmitted light detector) or by the scattered light scattered by the particles (scattered light detector).

For this purpose, the light receiver is oriented with the light path defined by the light transmitter in such a way that its incidence region intersects the light path. The detection region is therefore an intersection region which is formed by superimposing the light path of the light transmitter or its light source and the incidence region of the light receiver or its light sensor. In a transmitted light detector, the light receiver is arranged within the light path of the light transmitter and opposite to it; the angle between the optical axis of the light transmitter and the light receiver corresponds to 0°. In a scattered light detector, the optical axis of the light transmitter and that of the light receiver form an angle greater than 0°, the so-called scattered light angle. The control module is configured to detect and evaluate particles in the detection region based on the light intensity signal transmitted by the light receiver.

Another application is aspirating smoke detectors, also known as aspirating particle detection systems. An aspirating particle detection system comprises at least one pipe and/or hose line which opens into one or more monitoring regions via one or more suction openings for the respective withdrawal of a fluid, in particular an air, sample. For example, several monitoring regions can be located in different regions of a common space, such as a (large) warehouse, but also in individual rooms of a building or sections of a vehicle, such as the passenger cabins of a ship. The collected fluid samples are guided along the pipe and/or hose line, following a flow path, to the particle detection unit and passed through its detection region.

A particle detection unit designed as a scattered light detector for an aspirating particle detection system is known, for example, from U.S. Pat. No. 9,128,047 B2. The particle detection unit has a detection chamber with an inlet and an outlet. The air flow generated by the aspirating system flows through the detection chamber, so that aspirated air samples enter the chamber via the inlet and leave it again via the outlet. Furthermore, the detection chamber comprises two light transmitters designed to illuminate the air flow. Light scattered by particles in the air stream is to be detected by two light receivers. The two light receivers are oriented in such a way that their fields of view or regions of incidence do not overlap each other, but form a respective intersection region with the light volume or light path of the light transmitters. This orientation defines two spatially independent detection regions within the detection chamber that are to be examined. For further evaluation of the detected particles, the light transmitters emit light of different wavelengths. Based on the respective intensity of the light detected in the detection regions, characteristic properties of the particles in the detection region are to be determined. For example, a light-emitting diode can be used as a light transmitter and a photodiode as a light receiver.

Light-emitting diodes (LEDs) are diodes that emit light when an electrical current flows through them. A common structure of a light-emitting diode includes the LED chip, the actual diode, which allows electrical current to pass in one direction, the so-called forward direction, and blocks it in the other direction. Light-emitting diodes are configured in such a way that when current flows through the LED chip in the forward direction, light is emitted; the LED chip therefore acts as the light source of the light-emitting diode. Another component of the light-emitting diode is the housing, which is usually made of a transparent material such as plastic or glass and serves to focus or align the emitted light along a rotation or symmetry axis, also known as the “optical axis”. Instead of a housing, a lens can also be provided for bundling or orientation and arranged directly in front of the LED chip. The light emitted by the light-emitting diode and bundled along the optical axis defines a light path and is comparable, for example, to the light cone of a flashlight. The optical axis of the light-emitting diode or light transmitter usually corresponds to the central or rotational axis of the defined light path. The light-emitting diode can be connected to a voltage or current source using two terminals. Light-emitting diodes can have one or more LED chips, i.e. several light sources in the same housing.

From a physical perspective, the light emitted by a light source corresponds to a plurality of individual light rays. For the purposes of this invention, the term “light path” is understood to mean the space or region occupied by the totality of all light rays emitted by a single light source. The light path of a light source is therefore defined by the light emitted by the light source, regardless of the actual operating state of the light source. In other words, the light path is also present if the light source is switched off, i.e. does not emit any light. A “common light path” in the sense of this invention is the superposition region within which the light beams emitted by two or more light sources, i.e. their respective light paths, overlap.

In order to detect the light emitted by one or more light sources, the diode or photo chip of the photodiode is configured as a light sensor, so that an electric current or voltage is generated when light hits it. Unlike light-emitting diodes, photodiodes do not emit light, but can detect incoming light, especially incoming light rays, and convert them into electrical signals. Similar to the light path of a light-emitting diode, which is defined by the totality of the emitted light rays, the so-called “incident region” of a photodiode is defined by the totality of the light rays that can be detected by the photodiode. The optical axis of the photodiode or light sensor usually corresponds to the central or rotational axis of the defined region of incidence. A “common incidence region” in the sense of this invention is the overlap region within which the respective incidence regions of two or more light sensors overlap.

The light from a light source is usually composed of electromagnetic radiation of different wavelengths. For example, an LED chip emits light with a central or characteristic wavelength and a distribution around this characteristic wavelength in the range of about +/−30 nm. For infrared diodes, for example, the characteristic wavelength in the infrared range (e.g. 840 nm, 880 nm, 940 nm, etc.) is specified. However, the light emitted by the diode does not exclusively correspond to this specified characteristic wavelength, but can also be measured in a range of approximately +/−30 nm around the characteristic wavelength with sufficiently high light intensity. When a laser is used as a light source, the wavelength range around the characteristic wavelength is much narrower and is usually in the range of only +/−1 nm. The totality of the wavelengths emitted by the light source can be represented as a so-called spectral band, which represents the position of the electromagnetic radiation in the electromagnetic spectrum, with one wavelength corresponding to one spectral line. The totality of all spectral lines forms a spectral band characteristic of the light emitted by the light source. A light sensor is also usually designed to detect light of several different wavelengths. Consequently, the light that can be detected by a light sensor can also be assigned a characteristic spectral band or a characteristic wavelength.

From WO 2020/247187 A1, a ceiling smoke detector with a housing and a detection chamber formed therein is known. Several light sources, designed as respective light transmitters, send light of different wavelengths into the interior of the detection chamber. For this purpose, several LED chips should be arranged on a common circuit board. Each LED chip is designed as a separate light emitter with its own housing and lens to focus or align the emitted light along a cone-shaped light path. The central axis of this light cone corresponds to the optical axis of the light transmitter. The light emitted by the light transmitters can be detected by a photodiode. The optical axis of the photodiode and the optical axes of the light emitters include the scattered light angles (forward and backward scattering) specific to the respective light emitters and required to determine particle properties.

European patent EP 3 029 646 B1 also discloses a ceiling smoke detector with light sources of different characteristic wavelengths. However, according to the disclosure, two single-colored LED chips are combined to form a single light-emitting diode, i.e. a single light transmitter with two light sources. The LED chips are arranged next to each other on a chip carrier so that the respective geometric center of the two LED chips is at the same distance from the main optical axis of the light-emitting diode. The light emitted by each LED chip overlaps each other, thus defining a common light path along the main optical axis of the light-emitting diode. A photosensor is oriented with the common light path so that the main optical axis of the light-emitting diode and the optical receiver axis of the photosensor enclose a scattered light angle with each other. By accommodating two LED chips in the housing of a single light-emitting diode, a scattered light arrangement with only one scattered light angle for both colors of the LED chips is to be achieved.

From EP 3 779 909 B1, a fire detection device in the form of a ceiling smoke detector is known, comprising a first and a second light emission unit which enclose a respective scattered light angle with a light receiving unit. Due to the different scattered light angles, the light receiving unit can output a light receiving signal specific to the first and second light emitting units. To determine the type of smoke detected, the fire detection device also has an identification unit. The identification unit is designed to determine the type of smoke based on the output ratio of the light reception signals and their rate of increase. The disadvantage here is that, in order to ensure a reasonably reproducible determination of the type of smoke, the rate of increase and thus a temporal component of at least one light reception signal must also be taken into account. This not only makes the evaluation of the received signal more complicated, but also delays it.

Finally, EP 3 494 561 B1 describes a photoelectric smoke detector that is said to be able to distinguish small particles generated by harmless activities, such as frying burgers, toasting bread, etc., from smoke indicating a fire hazard, thus meeting the requirements of the US standards UL 217-8 and UL 268-7. Accordingly, smoke detectors must be able to avoid false alarms caused by cooking or frying (so-called “hamburger test”). For this purpose, the smoke detector comprises a first, second and third light emitter, each designed as a light-emitting diode, a light receiver and a control unit. The light receiver is designed to detect light emitted by the light emitters and scattered by particles along a light-receiving axis and to output respective output signals corresponding to the light emitters. The first and second light emitters are arranged such that their respective optical axes enclose the same first scattered light angle with the light-receiving axis of the light receiver. To differentiate the output signals, the first light emitter emits light in the infrared wavelength range and the second light emitter emits light in the blue wavelength range. The third light emitter also emits light in the infrared wavelength range, but its output signal is to be identified based on a scattered light angle that differs from that of the first light emitter. The signals output by the light receiver are evaluated by the controller, wherein a respective ratio of the first to the second output signal, the second to the third output signal and the first to the third output signal is formed. The disadvantage here is the complicated structure, with a total of three light transmitters, some of which include different scattered light angles with the light receiver.

It is therefore the object of the present invention to eliminate the disadvantages of the prior art and to provide a compact and space-saving particle detection unit with as few components as possible as well as a classification method that makes it possible to classify detected particles reliably and reproducibly.

The object is achieved by a method for classification according to claim 1 and a particle detection unit according to claim 12.

### SUMMARY OF THE INVENTION

A classification method according to the invention of the type described in more detail at the outset is characterized in that at least a first light intensity signal and a second light intensity signal are determined, which are based on light detected by the light receiver of a first characteristic wavelength and a second characteristic wavelength deviating from the first characteristic wavelength, and in addition thereto a further light intensity signal, namely a reference light intensity signal is determined, which is based on light detected by the light receiver of a characteristic reference wavelength that deviates from the first and the second characteristic wavelength, and any further (a third, fourth, etc.) characteristic wavelengths.

The at least first and second light intensity signals, and any further light intensity signals, are each set in relation, in particular in proportion to the one, i.e. the same, reference light intensity signal, and the relation values thus obtained are ranked in a classification map. Based on the ranking within the classification map, the detected particles are finally allocated to a defined particle class.

In the sense of the invention, different light intensity signals are determined which are based on light of different wavelengths. Each light intensity signal indicates the intensity distribution of the detected light in the electromagnetic spectrum and contains information about the respective wavelengths and their intensity. The determined light intensity is also based on the number or quantity of particles in the detection region that either scattered the scattered light received by the light receiver or reduced the transmitted light received by the light receiver. The information about the wavelengths depends, for example, on the light sources or corresponding filters used, especially color filters, and can be used to determine particle properties such as size, surface texture or color. Based on such particle properties, conclusions can then be drawn about the type of particles detected in the detection region, in particular to determine whether they are smoke particles or aerosols that indicate a fire or its origin, or whether they are merely a deceptive quantity, e.g. caused by the preparation of food. The particle classes to be identified and differentiated from one another using the classification method according to the invention are, in particular, particles that indicate an actual dangerous situation, such as smoke particles that signal a fire or the onset of a fire. To avoid false alarms, these should be distinguished from other particle classes, e.g. smoke particles that occur during preparation, especially when frying food (“hamburger test”), from fat particles, aerosols, water vapor, weather-related fog or even insects.

To identify the particle class, the classification method according to the invention comprises a classification map which corresponds in particular to a coordinate system. The number of axes of the coordinate system corresponds to the number of different characteristic wavelengths minus 1. If, for example, a total of three are used, i.e. a first and a second characteristic wavelength as well as a characteristic reference wavelength, the coordinate system therefore comprises two axes. The obtained relation values then form a pair of values, which is classified in the classification map or entered into the coordinate system in the manner of a coordinate.

If, for example, a third characteristic wavelength is used, i.e. a total of four different characteristic wavelengths, the coordinate system has three axes, and so on.

The determined light intensity signals are not limited to the first and second light intensity signals or to only two characteristic wavelengths. If required, further different or even identical light intensity signals can be determined, which are then based on light of a third or fourth characteristic wavelength, etc. For example, it is conceivable to determine two further, third light intensity signals and/or one further, third light intensity signal and one further, fourth light intensity signal. By determining additional light intensity signals, the accuracy and specificity of the classification procedure can be further improved. Light of different characteristic wavelengths can be generated, for example, by using light sources of different colors or with only one or more light sources of the same color in combination with filters, in particular color filters. The filters can then either be assigned to the light receiver, i.e. provided on the “light receiver side”, or assigned to the light transmitter, i.e. provided on the “light transmitter side”. Preferably, all light sources are combined into a single light transmitter or all filters or light sensors into a single light receiver.

According to the invention, it is further provided to classify particles detected within the detection region by means of spectral analysis. For this purpose, respective, in particular different, light intensity signals are determined and the determined light intensity signals are each related to the same, the reference light intensity signal. Such a “relating” or “forming a proportion” of a determined light intensity signal to a similar, predefined light intensity signal, the reference light intensity signal, corresponds to a type of scaling in which the intensity information based on the quantity or number of particles in the detection region is adapted or scaled to the currently measured total level of all determined light intensity signals. Preferably, all light intensity signals are determined in a single, identical detection region, so that the respective signals are also based on the same particles present therein or their number or quantity.

By forming a relation or a proportion of the respective light intensity signals with the same reference light intensity signal, this number or quantity component can be eliminated, whereby the information content of the light intensity signal can be reduced to the information essential for classification, i.e. for determining the type of particle, e.g. particle properties such as size, surface texture or color. A relation value therefore corresponds to a light intensity signal whose information content is reduced to the particle properties. In this way, the classification process can be significantly simplified, resulting in faster and more reliable results.

According to an advantageous variant of the method, the relation values formed from the light intensity signals are assigned to respective axes defining the classification map, which is implemented in particular as a coordinate system.

The dimension of the classification map corresponds to the number of determined relation signals, and the relation signals correspond to a coordinate. Preferably, the axes defining the classification map have a scaling such that the determined amount of a respective relation value corresponds to a predetermined position on the scaling of the associated axis.

In the exemplary application case of a two-dimensional classification map, the two determined relation values therefore form a pair of values, which can be entered into the classification map using the axis scaling. If there are three or more relation signals in total, the coordinate accordingly comprises three or more values.

For example, in the case of a first and a second light intensity signal, which is based on light of a first and a second characteristic wavelength, respectively, a two-dimensional classification map is defined, in particular a two-dimensional coordinate system is spanned. The relation value formed from the first light intensity signal to the reference light intensity signal is then assigned to one of the axes, e.g. the ordinate, and the relation value formed from the second light intensity signal to the reference light intensity signal is assigned to the other axis, e.g. the abscissa. The relation values formed correspond to the coordinates of a light intensity signal based on a characteristic wavelength within the classification map.

The number of relation values formed therefore determines the dimension of the classification map, which thus depends directly on the number of different characteristic wavelengths detected by the light receiver. By using light of three different characteristic wavelengths and a different characteristic reference wavelength and the corresponding detection of three different light intensity signals and the reference light intensity signal, a three-dimensional classification map or a three-dimensional coordinate system could be created. Higher-dimensional classification maps can be evaluated using multivariate methods or self-learning algorithms.

In principle, it is conceivable that the creation of regions contained in the classification map and corresponding to the respective particle classes, to which the detected particles are assigned, is carried out by a learning process of a self-learning computer program or an artificial intelligence during the commissioning and/or ongoing operation of the method. The disadvantage, however, is that the division of the regions, or the underlying parameters and relationships, cannot be easily understood, since such computer programs operate autonomously; they are also referred to as a “black box”.

According to a variant of the method according to the invention, it is therefore advantageous that regions contained in the classification map and assigned to a defined particle class are determined based on physical variables, in particular in advance.

For example, in a two-dimensional classification map, a respective particle class is assigned to a specific, planar region, while in a three-dimensional classification map, it is assigned to a specific, spatial region.

For example, such a reference formation can be carried out before commissioning a particle detection unit by target introduction of the particle class to be determined, e.g. smoke particles or aerosols that indicate a fire or its origin into the detection region. The relation values thus obtained are then entered into the classification map and form a kind of cluster, i.e. they are more frequently present in certain regions of the classification map. Based on the distribution within the classification map, in particular on the basis of the clusters formed, a region corresponding to the particle class, for example the smoke indicating a fire, is defined, which allows an assignment to this particle class with a sufficiently high probability (e.g. >95.0%). Advantageously, the regions are formed around a center in such a way that the center corresponds to the highest probability (e.g. >99.9%) and the boundary of a region corresponds to the minimum required probability (e.g. =95.0%). Starting from the center and moving towards the boundary of a region, the probability that a relation value classified within it is actually based on the detection of particles of the assigned particle class decreases.

In contrast to a computer-assisted learning process, which is based purely on mathematical principles, a classification map created in this way is based on measured physical quantities, which makes the results, i.e. the specific regions or clusters determined for certain particle classes, comprehensible and reproducible.

In a further development of this process variant, the regions of the classification map are determined using characteristics in the electromagnetic spectrum that are specific to the particle class to be defined and detected by the light receiver. The characteristics determined include, for example, the particle- , frequency- and solid angle-dependent differential scattering cross section and/or the particle-dependent scattering coefficients of the Mie theory.

The number of spectral bands and/or spectral lines required to define a region with a sufficiently high probability is then also decisive for the number of required, in particular different, characteristic wavelengths that are required to identify the detected particles and to rank them into a particle class with a sufficiently high probability. For example, in order to distinguish smoke generated by a fire from particles and aerosols generated when frying burgers, toasting bread, etc., the use of three different characteristic wavelengths, with one of the wavelengths being used as the characteristic reference wavelength, has proven particularly advantageous.

The following process variants of the classification method according to the invention are therefore each described in more detail using the example of two different characteristic wavelengths and a different characteristic reference wavelength. Of course, the following variants can also be applied accordingly in the case of further, for example a third, fourth, etc. characteristic wavelengths.

According to an optional method variant, the characteristic wavelengths of the light detected by the light receiver are defined by at least two light sources and a reference light source of the light transmitter, in particular a single light transmitter, each of the light sources emitting light of a respective characteristic wavelength.

According to another, likewise optional, method variant, the characteristic wavelengths of the light detected by the light receiver are defined by at least two light sensors and a reference light sensor of the light receiver, in particular a single light receiver, wherein each of the light sensors is configured to detect light of a respective characteristic wavelength. Such a configuration can be achieved, for example, by using filters, in particular color filters, specific for the desired characteristic wavelength or characteristic reference wavelength. Each light sensor and the reference light sensor is then assigned a respective filter.

According to these optional variants, the provision of the different characteristic wavelengths required for the classification of particles detected in the detection region as well as the deviating characteristic reference wavelength can be carried out either on the light transmitter side or the light receiver side or even on the light transmitter and light receiver side.

In an advantageous development of these optional method variants, the light emitted by the at least two light sources and the reference light source at least partially overlap one another, defining a common light path along the optical axis of the light transmitter, and/or the light detected by the at least two light sensors and the reference light sensor at least partially overlap one another, defining a common region of incidence along the optical axis of the light receiver.

By superimposing the light paths of the respective light sources into a common light path, it can be ensured that the light intensity signals detected by the light receiver are each based on the same particles located in the detection region. Any disturbances within the common light path, such as contamination that result in a change in the light intensity, can thus be eliminated. In this way, essentially identical environmental conditions can be created. The larger the overlap region, i.e. the common light path, the higher the proportion of the emitted light this applies to. For example, the overlap is at least 50%, preferably in a range between 80 to 100%, in particular between 90 to 100% and particularly preferably between 95 to 100%. The same applies to the common incidence region, which is why the overlap of the incidence regions of several light sensors of a light receiver is, for example, at least 50%, preferably in a range between 80 and 100%, in particular between 90 and 100% and particularly preferably between 95 and 100%.

According to a further exemplary method variant, the light of each characteristic wavelength is detected by the light receiver simultaneously or sequentially. It has proven particularly advantageous in terms of circuitry to determine at least the reference light intensity signal at a different time, in particular immediately before or after the determination of the first and second light intensity signals.

Another, equally exemplary method variant provides that the characteristic wavelengths of the light detected by the light receiver are in the infrared or red range, ie in a wavelength range between approximately 940 nm-640 nm, particularly preferably 940 nm, in the green range, ie in a wavelength range between approximately 570 nm-490 nm, particularly preferably 530 nm and/or in the blue range, ie in a wavelength range between approximately 490 nm-430 nm, particularly preferably 450 nm.

In a further development of this exemplary method variant, the light with the first characteristic wavelength, in particular in the blue range, is used for the continuous detection of particles by means of the particle detection unit, wherein particles located in the detection region are detected by means of a change in its light intensity signal.

The light with the second characteristic wavelength, in particular in the infrared or red range, and the light with the characteristic reference wavelength, in particular in the green range, are used to classify the detected particles, wherein the light intensity of the light with the characteristic reference wavelength detected by the light receiver is determined as a reference light intensity signal, and the light intensity of the light with the first characteristic wavelength and the second characteristic wavelength detected by the light receiver is determined as a first and second light intensity signal, and these are related, in particular proportioned, to the reference light intensity signal determined by the light receiver in the manner of a scaling.

In such a further developed method variant, for example, the detection region can be exposed to blue light from a light source at regular (short) time intervals for the continuous detection of particles. As soon as a change in the first light intensity signal indicates the presence of particles in the detection region, the two additional light sources, with light in the infrared or red range or with green light, can be switched on. The green light is used to determine the reference light intensity signal, wherein the light intensity signals of the blue and red or infrared light are then related to it. Based on the relational values obtained in this way, which function as a key figure, the particles can be ranked in the classification map and finally assigned to a particle class.

Finally, according to an advantageous embodiment of the invention, the method is stored as a programming on a memory element of a control module of the particle detection unit, wherein the control module is connected to the light transmitter in a signal-transmitting manner in order to control the latter to emit light, and is connected to the light receiver in a signal-transmitting manner in order to receive the light intensity signals detected by the light receiver. Preferably, the classification map required for assignment to a defined particle class has been empirically determined in advance on the basis of physical quantities and its data is stored on the memory element of the control module.

The object of the invention is therefore also achieved by a particle detection unit of the type described in more detail at the outset, which is suitable for carrying out the classification method according to one of the variants described above. Such a particle detection unit is characterized in that the light transmitter has at least a first light source configured to emit light of a first characteristic wavelength, and a second light source configured to emit light of a second characteristic wavelength, as well as a reference light source configured to emit light of a characteristic reference wavelength, and/or the light receiver has at least a first light sensor configured to detect light of a first characteristic wavelength, and a second light sensor configured to detect light of a second characteristic wavelength, as well as a reference light sensor configured to detect light of a characteristic reference wavelength.

The determination of the characteristic wavelengths and the characteristic reference wavelength can therefore be carried out either on the light transmitter side, for example by selecting different colored light sources, or on the light receiver side, for example by using filters, in particular color filters, assigned to the light receiver or its light sensors. However, a combination of these two possibilities is also conceivable, wherein, for example, a white LED is used on the light transmitter side, and the first characteristic wavelength as well as the second characteristic wavelength and the reference wavelength on the light receiver side are determined by three corresponding filters, in particular color filters.

According to the invention, the first and second light sources and the reference light source of the light transmitter are oriented with one another in such a way that the light emitted in each case at least partially overlaps one another, defining a common light path along the optical axis of the light transmitter, and/or the first and second light sensors and the reference light sensor of the light receiver are oriented with one another in such a way that the light detectable by the respective light sensor at least partially overlaps one another, defining a common region of incidence along the optical axis of the light receiver.

Preferably, all light sources used are combined into a single light transmitter, e.g. an LED with several adjacent LED chips arranged on a common circuit board and/or all light sensors are combined into a single light receiver, e.g. a photodiode with a plurality of adjacent photo chips arranged on a common circuit board. In this case, the light transmitter has a common light path and the light receiver has a common region of incidence. If only a single light source is used, which then corresponds to the light transmitter, the latter has a (single) light path; accordingly, a light receiver designed with only a single light sensor also has a (single) region of incidence.

According to the invention, to define the detection region, the region of incidence or the common region of incidence of the light receiver is oriented with the common light path of the light transmitter or the light path or common light path of the light transmitter is oriented with the common region of incidence of the light receiver.

By means of such an orientation, light of at least a first and a second characteristic wavelength as well as a characteristic reference wavelength present in one and the same detection region can be scattered by particles located therein or reduced by particles located therein. The scattered light scattered by the particles or the transmitted light reduced by the particles can be detected using corresponding light intensity signals, each of which is influenced by the same particles located in the detection region. By having the light sources and/or the light sensors form a common light path or region of incidence, it is also ensured that other factors or disturbances that affect the light intensity signals, such as contamination, are identical within the light path. In this way, the determined reference light intensity signal can be used as a similar, fixed reference value for scaling at least the first and second light intensity signals as well as any further light intensity signals in the classification method described above.

According to an advantageous embodiment of the particle detection unit according to the invention, the light sources and/or the light sensors are configured by respectively assigned filters, in particular color filters, for emitting or detecting light of a respective characteristic wavelength.

The use of filters is therefore conceivable not only on the light receiver side, but also on the light transmitter side. This makes it possible, in particular, to use only one or several light sources of the same color, whose characteristic wavelengths are then determined by respective filters.

In a preferred embodiment of the invention, the light transmitter is designed as a light-emitting diode and the light receiver as a photodiode, wherein the light transmitter comprises at least a first LED chip, a second LED chip and a reference LED chip and/or the light receiver comprises at least a first photo chip, a second photo chip and a reference photo chip.

The LED chips then correspond to different light sources of the light transmitter and the photo chips to different light sensors of the light receiver.

In a further development of this embodiment of the invention, the first and second LED chips as well as the reference LED chip are arranged directly adjacent to one another on a common base plate, in particular a printed circuit board, and the light emitted by them is oriented and/or bundled along a common optical axis by means of an optical means, in particular a lens.

Optionally or alternatively, the first and second photochips as well as the reference photochip can be arranged directly adjacent to one another on a common base plate, in particular a printed circuit board, and their respective incidence regions can be oriented and/or bundled along a common optical axis by means of an optical means, in particular a lens.

The common optical axis then corresponds to the optical axis of the light transmitter or the optical axis of the light receiver.

According to a further, likewise preferred embodiment of the particle detection unit according to the invention, the light sources, in particular all of the light sources of the light transmitter and the light receiver each enclose the same scattered light angle and are each oriented with the incidence region of the light receiver to define a single, identical detection region.

Alternatively, the light sensors, in particular all light sensors of the light receiver with the light transmitter, can each include the same scattered light angle and be oriented with the light path of the light transmitter to define a single, identical detection region.

Preferably, the control module also comprises a memory element which comprises a programming and a classification map for carrying out a method according to one of the variants described above.

Finally, according to an exemplary embodiment, the particle detection unit can be part of an aspirating particle detection system, with at least one pipe and/or hose line, which opens into one or more monitoring regions via one or more suction openings for the respective withdrawal of a fluid sample. The light transmitter and the light receiver are then oriented to each other to define a detection region, in particular a single detection region within a flow path through which the fluid samples can flow.

### BRIEF DESCRIPTION OF THE SEVERAL VIEWS OF THE DRAWINGS

Further details, features, (sub) combinations of features, advantages, and effects on the basis of the invention result from the following description of preferred exemplary embodiments of the invention and the drawings. The figures respectively show

FIG. 1 a schematic representation of an embodiment of a particle detection unit according to the invention with a light transmitter and a light receiver in a first exemplary configuration,

FIG. 2 a schematic detailed view of the first exemplary configuration of the light transmitter and the light receiver of the particle detection unit from FIG. 1,

FIG. 3 a schematic representation of exemplary arrangements of light sources on a base plate of the light transmitter according to the first exemplary configuration from FIGS. 1 and 2,

FIG. 4 a schematic detailed view of a second exemplary configuration of a light transmitter and a light receiver of an embodiment of the particle detection unit according to the invention,

FIG. 5 a schematic representation of an exemplary arrangement of a light source on a base plate of the light transmitter and multiple light sensors on a base plate of the light receiver according to the configuration of FIG. 4,

FIG. 6 a schematic representation of an aspirating particle detection system with an integrated particle detection unit according to FIG. 1,

FIG. 7 a flow chart of an exemplary sequence of the classification method according to the invention,

FIG. 8 a schematic representation of an exemplary circuit of a first and a second light source and a reference light source,

FIG. 9 an exemplary representation of a classification map with a total of three regions assigned to a respective particle class,

FIG. 10 an exemplary representation of a respective probability curve within the regions of the classification map from FIG. 10 and

FIG. 11 an exemplary plot over time of the light intensity signals determined by the light receiver for three characteristic wavelengths.

The figures are merely exemplary in nature and only serve to understand the invention. The same elements are given the same reference numbers.

### DETAILED DESCRIPTION OF THE INVENTION

The following detailed description of exemplary embodiments of the particle detection unit according to the invention and exemplary variants of the classification method according to the invention uses the example of a first and a second, mutually different characteristic wavelength and a characteristic reference wavelength deviating therefrom. Of course, the following embodiments and method variants are also applicable to further characteristic wavelengths, for example a third characteristic wavelength, a fourth characteristic wavelength, etc.

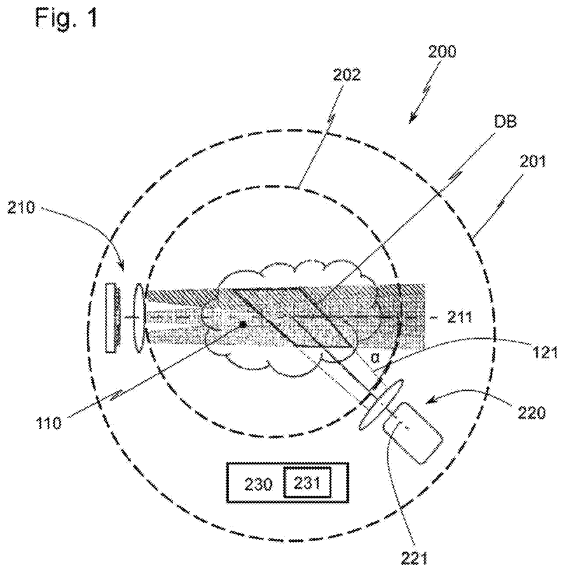

FIG. 1 shows a perspective view of a first exemplary embodiment of a particle detection unit 200 according to the invention. The particle detection unit 200 comprises a housing 201 within which a light transmitter 210, a light receiver 220 and a control module 230 are arranged. The light transmitter 210 and the light receiver 220 are shown here in a first exemplary configuration, wherein the light transmitter 210 is configured to emit light along a common light path 110 and is directed into the interior of the detection chamber 202 of the particle detection unit 200. In order to detect at least a portion of the emitted light, in the example shown here a scattered light portion, the incident region 121 of the light receiver 220 is also directed into the interior of the detection chamber 202, so that the common light path 110 of the light transmitter 210 and the incident region 121 of the light receiver 220 overlap in the interior of the detection chamber 202. This overlap region defines the detection region DB, within which particles, e.g. smoke particles are detectable. The optical axis 211 of the light transmitter 210 and the optical axis 221 of the light receiver 220 intersect each other in the detection region DB and enclose the scattered light angle a there. Light emitted by the light transmitter 210, which is scattered by particles located in the detection region DB at the scattered light angle a, is detected by the light receiver 220 and can thus be used to detect the particles. The particle detection unit 200 is shown in FIG. 1 using a scattered light arrangement. Of course, a design as a transmitted light arrangement is also possible, in which case the light transmitter 210 and the light receiver 220 would then be arranged opposite one another, i.e. their optical axes 211, 221 would enclose an angle of 0° with one another. The control module 230 is connected to both the light transmitter 210 and the light receiver 220 for signal transmission and is configured to control the light transmitter 210 and to detect and evaluate the signals transmitted by the light receiver 220. For this purpose, corresponding programming can be stored on a memory element 231 of the control module 230.

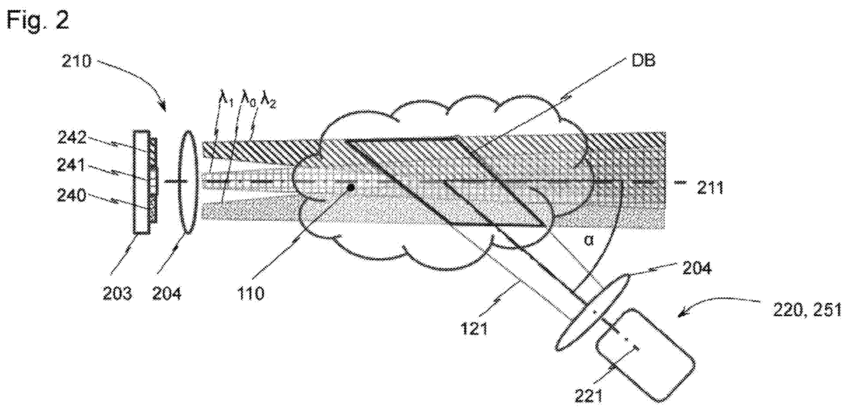

FIG. 2 shows a schematic detailed view of the scattered light arrangement of the particle detection unit 200 from FIG. 1. In the first exemplary configuration shown here, the light transmitter 210 is a light-emitting diode with a total of three LED chips, which function as a first light source 241 configured to emit light of a first characteristic wavelength λ₁, a second light source 242 configured to emit light of a second characteristic wavelength λ₂, and a reference light source 240 configured to emit light of a characteristic reference wavelength Ao. The LED chips, namely the light sources 240, 241, 242 are arranged directly adjacent to one another on a common base plate 203, so that their respective light paths overlap one another and define a common light path 110 along the optical axis 211 of the light transmitter 210. The common light path 110 is oriented and focused along the optical axis 211 by an optical means 204, here a lens. By using the optical means 204, the superposition region within which the light emitted by the individual light sources 240, 241, 242 is superimposed can be enlarged, among other things. The light sources 240, 241, 242 are also combined into a single light transmitter 210. In the specific embodiment shown, this means that three LED chips are each designed as a component of the same light-emitting diode, ie they are each directly adjacent to one another or in close proximity to one another and are connected to the same base plate 203, in particular a printed circuit board, and are focused by a common lens 204 along the optical axis 211 of the light-emitting diode.

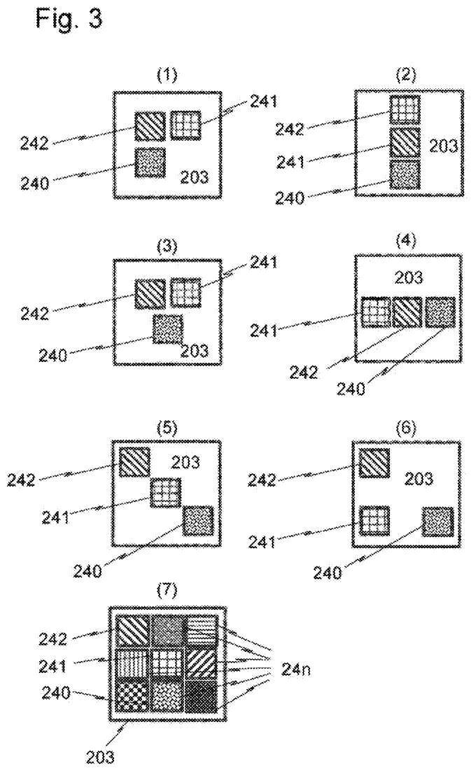

FIG. 3 shows exemplary arrangements (1) to (6) of the three light sources 240, 241, 242 on the base plate 203. Conveniently, all light sources 240, 241, 242 are arranged on the same side of the base plate 203. The light sources 240, 241, 242 are oriented such that their respective light path runs orthogonal to the surface of the base plate 203 and the respective optical axes are oriented parallel to each other. Furthermore, a further exemplary arrangement (7) with a total of nine light sources 240, 241, 242, 24n designed as LED chips on the base plate 203 is shown. In addition to the reference light source 240, as well as the first and second light sources 241, 242, six further light sources 24n are provided here by way of example, which can be used redundantly if required, ie are configured to emit light, for example, also of the first or second characteristic wavelength λ₁, λ₂, or are configured to emit light of further, different characteristic wavelengths λₙ. By combining all light sources 240, 241, 242, 24n into a single light transmitter 210, the light receiver 220 (see FIG. 2 again) can detect light from each of the light sources 240, 241, 242, 24n, i.e. with a different characteristic wavelength, namely the first characteristic wavelength λ₁, the second characteristic wavelength λ₂, the characteristic reference wavelength λ₀ and any further characteristic wavelength λₙ, which, however, was scattered by particles present in the same detection region DB and at the same, identical scattered light angle α.

According to FIG. 2, the light receiver 220 is oriented with its incidence region 121 onto the common light path 110. In the example shown, the light receiver 220 is designed as a photodiode with a photo chip functioning as a single light sensor 251 and is connected to a base plate 203, not shown here, in particular a printed circuit board. Immediately in front of the light sensor 251, an optical means 204, for example a lens, is arranged. By means of the optical means 204, the incident region 121 of the light receiver 220 is oriented and focused along its optical axis 221 onto the common light path 110 of the light transmitter 210, so that scattered light from all three light sources 240, 241, 242 can be equally detected on particles located in the detection region DB defined in this way and scattered at the scattered light angle α.

The provision of light of different characteristic wavelengths λ₀, λ₁, λ₂ is realized according to the first exemplary configuration shown in FIGS. 1 and 2 by a total of three light sources 240, 241, 242 of the light transmitter 210, i.e. on the light transmitter side.

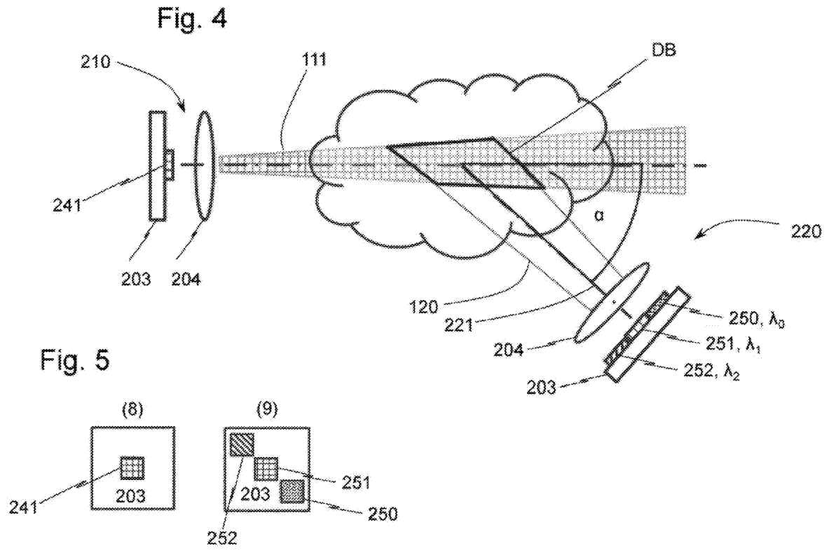

Deviating from this, FIG. 4 shows an exemplary embodiment of the particle detection unit 200 according to the invention, in which the provision of light of different characteristic wavelengths λ₀, λ₁, λ₂ is carried out by a second exemplary configuration on the light receiver side. The arrangement shown of light transmitter 210 and light receiver 220 essentially corresponds to the arrangement in FIGS. 1 and 2 and is therefore again described in more detail using a scattered light arrangement. Of course, a corresponding implementation could also be realized for a transmitted light arrangement. In contrast to the first exemplary configuration, the provision of light of different characteristic wavelengths λ₁, λ₂ as well as the characteristic reference wavelength Ao is realized here by a total of three light sensors 250, 251, 252 designed as photo chips of a photodiode on the light receiver side. The light sensors 250, 251, 252 are configured by means of respective associated filters, in particular color filters (not shown) for detecting light of the first and second characteristic wavelengths λ₁, λ₂ as well as the characteristic reference wavelength λ₀. The first and second light sensors 251, 252 and the reference light sensor 250 are oriented adjacent to one another such that the light detectable by the respective light sensors 251, 252, 250 superimposes a common incidence region 120 along the optical axis 221 of the light receiver 220. To define the detection region DB, the common incidence region 120 is oriented with the (here simple) light path 111 of the light transmitter 210, which in the configuration shown here is defined by a single light source 241, in particular designed as an LED chip.

An exemplary arrangement (8) of a single light source 241 arranged on a base plate 203 of the light transmitter 210, as well as an exemplary arrangement (9) of three light sensors 250, 251, 252 arranged on a common base plate 203 of the light receiver 220, can be seen in FIG. 5. In addition, further arrangements of the light sensors 250, 251, 252 or the use of additional light sensors according to the arrangements (1) to (7) of FIG. 3 are of course conceivable.

By superimposing all light sensors 250, 251, 252 to form a common incidence region 120, light with a different characteristic wavelength, the first characteristic wavelength λ₁, the second characteristic wavelength λ₂, the characteristic reference wavelength λ₀ and any further characteristic wavelength λₙ can be detected by the light receiver 220, which, however, has been scattered by particles present in the same detection region DB and at the same, identical scattered light angle α.

Based on the detected scattered light, the light receiver 220 outputs a light intensity signal I₀, I₁, I₂ specifically determined for the respective characteristic wavelength λ₀, λ₁, λ₂, which can be transmitted to the control module 230 connected for signal transmission. The light intensity signals I₀, I₁, I₂ are therefore based on (almost) identical environmental conditions, such as any disturbances, e.g. contamination within the light path, the number and quantity of particles in the detection region DB and the scattered light angle α at which the detected light was scattered by the particles. The physical variable underlying the light intensity signals I₀, I₁, I₂, which differ from one another, is the characteristic wavelength or reference wavelength λ₁, λ₂, λ₀. The light intensity signals I₀, I₁, I₂ that can be determined by the described configurations of light transmitter 210 and light receiver 220 are therefore particularly suitable for classifying particles or aerosols present in the detection region DB. Such a classification method can be used, for example, for fire detection in ceiling smoke detectors, but also in aspirated particle detection systems.

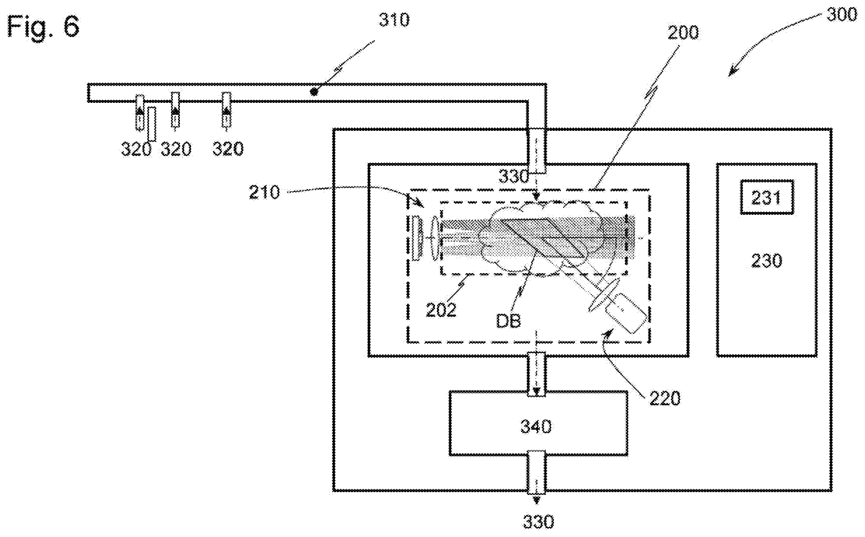

FIG. 6 shows a schematic representation of the first exemplary embodiment of the particle detection unit 200 from FIG. 1, which is part of an aspirating particle detection system 300. The aspirating particle detection system 300 comprises at least one pipe and/or hose line 310, which opens into one or more monitoring regions via one or more suction openings 320 for the respective withdrawal of a fluid sample. A fluid flow in the direction of the particle detection unit 200 can be generated within the pipe and/or hose line 310 by a flow means 340, in particular a fan, which fluid flow flows through the detection chamber 202 along a flow path 330. The particle detection unit 200 corresponds in its structure to the first exemplary configuration shown in FIG. 1 and comprises a light transmitter 210 and a light receiver 220. The light transmitter 210 and the light receiver 220 are oriented with each other such that the detection region DB is defined within the flow path 330 through which the fluid samples can flow. The control module 230 can also be used expediently to control components relevant to the aspirating particle detection system 300, for example the fluid 340. For this purpose, it is connected to corresponding components in a signal-transmitting manner and includes the necessary programming on a memory element 231.

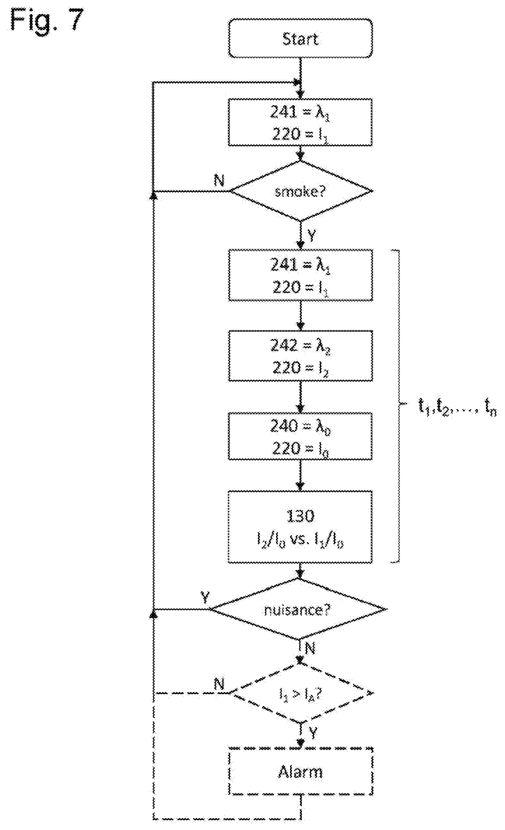

A flow chart of an exemplary variant of a classification method according to the invention, which is used for fire detection by means of a ceiling smoke detector or aspirating particle detection system 300, can be seen in FIG. 7. The classification method is explained in more detail below, based on a particle detection unit 200 with a first exemplary configuration according to FIGS. 1 and 2. To classify particles detected within the detection region DB, the light intensity signals I₀, I₁, I₂ determined by the light receiver 220 and transmitted to the control module 230 are used. For this purpose, the light transmitter 210 has a first light source 241 with a first characteristic wavelength λ₁, a second light source 242 with a second characteristic wavelength A2 and a reference light source 240 with a characteristic reference wavelength Ao. Preferably, the light transmitter 210 is designed as a light-emitting diode with three LED chips and the light receiver 220 as a photodiode with a single photo chip. Advantageously, the first characteristic wavelength λ₁ can be in the blue range, the second characteristic wavelength λ₂ can be in the red or infrared range and the characteristic reference wavelength λ₀ can be in the green range.

During operation of the particle detection unit 200, the first light source 241 is initially operated for the continuous detection of particles in the particle detection mode, wherein the control module 230 controls the first light source 241 to emit light of the first characteristic wavelength λ₁. At least a portion of the emitted light, in the example of the scattered light arrangement described here initially a comparatively small background scattered light portion, which is generated by light scattered and/or reflected inside the detection chamber 202, is detected by the light receiver 220 and a first light intensity signal I₁ based on the first characteristic wavelength λ₁ is determined. The first light intensity signal I₁ is stored in a memory unit of the control module 230 and evaluated by the latter. As long as no particles, e.g. in the form of smoke, are detected in the detection region DB (smoke=N), the described steps are repeated. The presence of particles in the detection region DB is detected by a change, in the example of a scattered light arrangement by an increase in the first light intensity signal I₁, since the scattered light scattered by the particles is now additionally detected by the light receiver 220.

If particles, in particular smoke, are detected in the detection region DB (smoke=Y), in order to classify the detected particles in a classification mode, the first light source 241 for emitting light of the first characteristic wavelength λ₁, the second light source 242 for emitting light of the second characteristic wavelength λ₂ and the reference light source 240 for emitting light of the characteristic reference wavelength λ₀ are controlled one after the other and the light intensity signals I₁, I₂, I₀ based on the respective characteristic wavelengths λ₁, λ₂, λ₀ and determined for a first time t₁ are stored on the memory unit 231. Preferably, the light intensity signals I₁, I₂, I₀ are determined redundantly at several successive times t₁, t₂, . . . , tₙ in order to verify the results obtained.

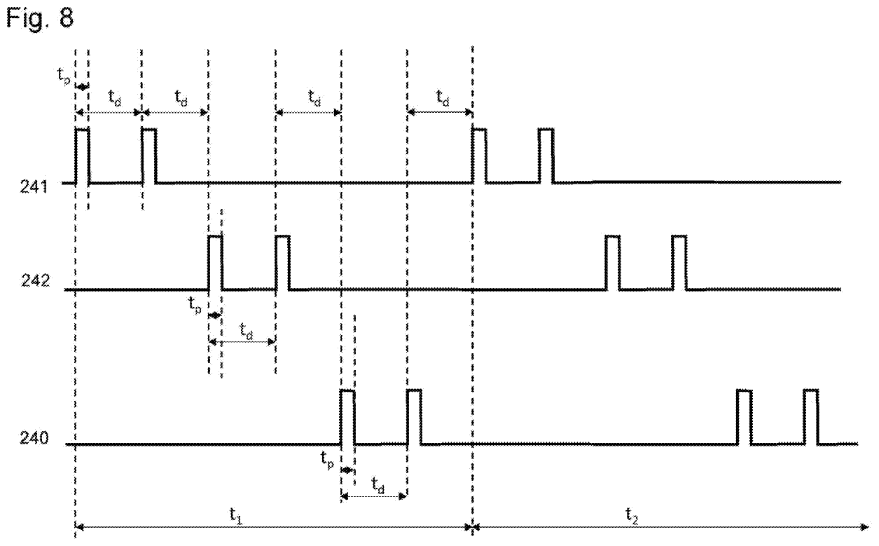

This is illustrated, for example, in FIG. 8 for two consecutive times t1 and t2. FIG. 8 shows a schematic representation of an exemplary control of the first and second light sources 241, 242 and the reference light source 240 for classifying detected particles. The light sources 241, 242, 240 can be designed as LED chips which are operated in a pulsed manner to emit light, with a respective pulse duration tₚ and an intermediate time interval t_{d}. A typical pulse duration tₚ is, for example, 4 ms, and the time interval t_{d} between the individual pulses is, for example, 200 ms. For the determination of the light intensity signals I₁, I₂, I₀ at a time t₁, for example, the light sources 241, 242, 240 are successively controlled to emit a respective pulse sequence consisting of two light pulses of pulse duration tₚ, which are successive with a time interval t_{d}. The time interval t_{d} also lies between the respective pulse sequences of the light sources 241, 242, 240. Based on the two light pulses (either by adding them together or by forming an average value), the respective light intensity signal I₁, I₂, I₀ can be determined at time t₁ and stored in the memory unit 231. The illustrated control of the light sources 241, 242, 240 and determination of the respective light intensity signals I₁, I₂, I₀ can be carried out successively for any further times t₃, t₄, . . . , tₙ.

Again shown using the exemplary flow chart of FIG. 7, respective relation values I₁/I₀, I₂/I₀ are formed from the determined light intensity signals I₁, I₂, I₀ stored in the memory unit 231 of the control module 230 by relating, in particular by forming proportions of, the first and second light intensity signals I₁, I₂ to the reference light intensity signal I₀. The relation values I₁/I₀, I₂/I₀ are classified in a classification map 130 which is created in advance and also stored on the memory unit 231. Based on the classification within the classification map 130, the particle is assigned to a defined particle class S₁, S₂, S₃.

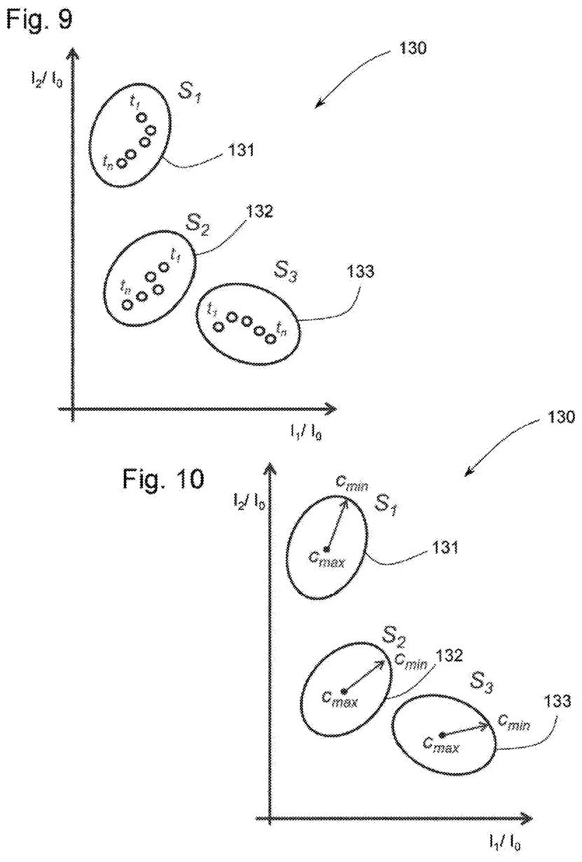

FIGS. 9 and 10 each show an exemplary classification map 130. The classification map 130 is created as a two-dimensional coordinate system, with each of the axes being assigned a relation value I₁/I₀, I₂/I₀. The classification map 130 contains a total of three regions 131, 132, 133, each of the regions 131, 132, 133 corresponds to an assigned particle class S₁, S₂, S₃. In FIG. 9, exemplary relation values for successive times t₁, t₂, . . . , tₙ (see also FIG. 8) are shown within the respective regions 131, 132, 133, which are entered into the classification map 130 using their coordinates I₁/I₀, I₂/I₀ and can be assigned to the corresponding particle class S₁, S₂, S₃ based on their positioning within one of the regions 131, 132, 133. FIG. 10 shows a probability curve Cₘₐₓ, Cₘᵢₙ within the respective regions 131, 132, 133. Thus, the probability that a relation value classified therein is actually based on the detection of particles of the assigned particle class S₁, S₂, S₃ lies in the center at a maximum value Cₘₐₓ, (e.g. 99.9%) and decreases towards the boundary of the region 131, 132, 133. At the boundary of the region 131, 132, 133, the probability Cₘᵢₙ (e.g. 95.0%) corresponds to the minimum required value in order to be able to assign particles to a particle class S₁, S₂, S₃ with sufficient certainty.

For the fire detection application, for example, the first region 131 can correspond to a first particle class S₁, such as the smoke or aerosols occurring in a polyurethane smoldering fire, the second region 132 to a second particle class S₂, such as the smoke or aerosols occurring in a wood smoldering fire, and the third region 133 to a third particle class S₃, such as the smoke or aerosols occurring when frying hamburgers, toasting bread, etc. In fire detection, this third particle class S₃ is evaluated as a nuisance, i.e. particles that are detected but should not trigger a fire alarm.

Returning to FIG. 7, the exemplary flow chart shown therein for the application of fire detection shows possible steps following the classification of the detected particles. These steps are purely optional and are specifically intended for the use of the classification method according to the invention for fire detection. Accordingly, if the detected particles are assigned to the third particle class S₃, i.e. have been classified as a disturbance variable (nuisance=Y), the procedure continues from the start with the detection of particles in the particle detection mode. If the detected particles are not recognized as a disturbance (nuisance=N) and at the same time the value of the first light intensity signal I₁ exceeds a previously set alarm threshold I_{A} (I₁>I_{A}=Y), an alarm message is issued. If the alarm threshold I_{A} is not exceeded (I₁>I_{A}=Y), the procedure is also continued from the start.

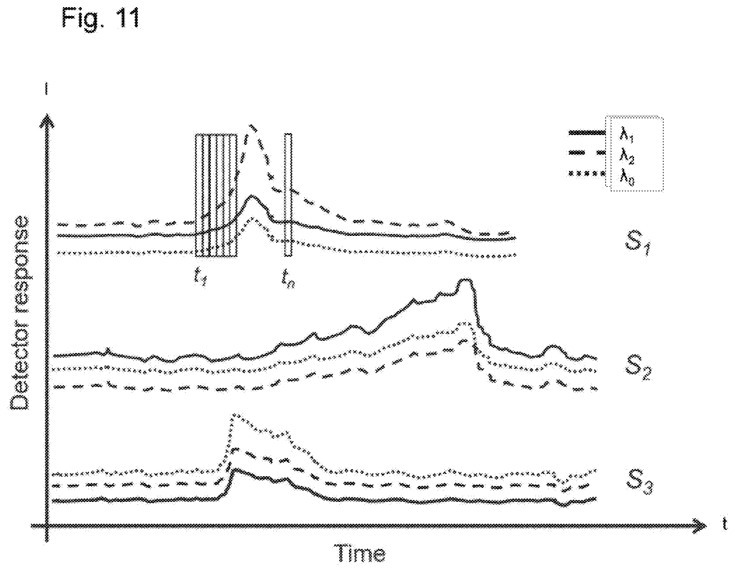

Finally, FIG. 11 shows an exemplary plot of the light intensity l over time t, the light intensity signals I₁, I₂, I₀ determined by the light receiver 220 for the first and second characteristic wavelengths λ₁, λ₂, as well as the characteristic reference wavelength λ₀. The corresponding value curve is shown within the same diagram for three different particle classes S₁, S₂, S₃. A specific increase for the respective particle class S₁, S₂, S₃ can be seen, namely of all light intensity signals I₁, I₂, I₀ based on the respective characteristic wavelengths λ₁, λ₂, λ₀. For the first particle class, successive times t₁, t₂, . . . , tₙ are also shown, at which the light intensity signals I₁, I₂, I₀ were determined. The data thus obtained for desired particle classes S₁, S₂, S₃ can be used for calibration, i.e. for creating the classification map 130. For this purpose, the light intensities I₁, I₂, I₀ determined at the successive times t₁, t₂, . . . , tₙ or the relational values I₁/I₀, I₂/I₀ formed therefrom are entered into the classification map 130. The resulting value clusters form the basis for determining the regions 131, 132, 133 corresponding to the respective particle classes S₁, S₂, S₃.

### LIST OF REFERENCE NUMERALS

110 common light path
111 Light path of the light transmitter
120 common region of incidence
121 region of incidence of the light receiver
130 classification map
131 first region of the classification map
132 second region of the classification map
133 third region of the classification map
200 particle detection unit
201 housing
202 detection chamber
203 base plate, in particular printed circuit board
204 optical means, in particular lens
210 light transmitter
211 optical axis of the light transmitter
220 light receiver
221 optical axis of the light receiver
230 control module
231 memory element
240 reference light source, in particular LED chip of a light-emitting diode
241 first light source, in particular LED chip of a light-emitting diode
242 second light source, in particular LED chip of a light-emitting diode
24n further light sources, in particular LED chips of a light-emitting diode
250 reference light sensor, in particular photochip of a photodiode
251 first light sensor, in particular photochip of a photodiode
252 second light sensor, in particular photochip of a photodiode
300 aspirating particle detection system
310 pipe and/or hose line
320 suction opening
330 flow path
340 flow means, especially fans
Cₘₐₓ, maximum probability
Cₘᵢₙ minimum probability
DB detection region
l light intensity
I_{A} Alarm threshold
I₁ first light intensity signal
I₂ second light intensity signal
I₀ reference light intensity signal
I₁/I₀, I₂/I₀ relational value
S₁, S₂, S₃ particle classes
smoke smoke
nuisance deceptive variable
Y Yes
N No
α scattered light angle
λ₀ characteristic reference wavelength, especially in the green range
λ₁ first characteristic wavelength, especially in the blue range
λ₀ second characteristic wavelength, especially in the infrared or red range
λₙ further characteristic wavelengths

1. A method for classifying particles detected by means of a particle detection unit (200), which particle detection unit (200) has a light transmitter (210) for emitting light and a light receiver (220) for detecting at least part of the emitted light, wherein the light transmitter (210) and the light receiver (220) are oriented with each other to define a detection region (DB), characterized in that
particles detected within the detection region (DB) are classified, wherein
at least one first light intensity signal (I₁) and one second light intensity signal (I₂) are determined, which are based on light of a first characteristic wavelength (λ₁) and a second characteristic wavelength (λ₂) deviating from the first characteristic wavelength (λ₁) detected by the light receiver (220),
a reference light intensity signal (I₀) is determined, which is based on light of a characteristic reference wavelength (λ₀) detected by the light receiver (220), which deviates from the first and the second characteristic wavelength (λ₁, λ₂),
the at least first and second light intensity signals (I₁, I₂) are each set in relation, to the reference light intensity signal (I₀),
the relation values (I₁, I₂, I₀) thus obtained are ranked in a classification map (130), and
on the basis of the ranking within the classification map (130), the detected particles are allocated to a defined particle class (S₁, S₂, S₃).

2. The classification method according to claim 2, characterized in that
the relation values (I₁/I₀, I₂/I₀) formed from the light intensity signals (I₁, I₂, I₀) are assigned to respective axes defining the classification map (130).

3. The classification method according to claim 2 characterized in that
regions (131, 132, 133) contained in the classification map (130) and assigned to a defined particle class (S₁, S₂, S₃) are determined based on physical quantities.

4. The classification method according to claim 3, characterized in that
the regions (131, 132, 133) of the classification map (130) on the basis of characteristics in the electromagnetic spectrum which are specific for the particle class (S₁, S₂, S₃) to be defined and which are detected by the light receiver (220).

5. The classification method according to claim 1, characterized in that the characteristic wavelengths (λ₁, λ₂, λ₀) of the light detected by the light receiver (220) are defined by at least two light sources (241, 242) and a reference light source (240) of the light transmitter (210), each of the light sources (241, 242, 240) emitting light of a respective characteristic wavelength (λ₁, λ₂, λ₀).

6. The classification method according to claim 1, characterized in that
the characteristic wavelengths (λ₁, λ₂, λ₀) of the light detected by the light receiver (220) are defined by at least two light sensors (251, 252) and a reference light sensor (250) of the light receiver (220), wherein each of the light sensors (251, 252, 250) is configured to detect light of a respective characteristic wavelength (λ₁, λ₂, λ₀).

7. The classification method according to claim 5, characterized in that
the light emitted by the at least two light sources (241, 242) and the reference light source (240) at least partially superimposes one another, defining a common light path (110) along the optical axis (211) of the light transmitter (210), and/or the light detected by the at least two light sensors (251, 252) and the reference light sensor (250) at least partially superimposes one another, defining a common incidence region (120) along the optical axis (221) of the light receiver (220).

8. The classification method according to claim 1, characterized in that
the light of respective characteristic wavelengths (λ₁, λ₂, λ₀) is detected by the light receiver (220) simultaneously or sequentially.

9. The classification method according to claim 8, characterized in that
the characteristic wavelengths (λ₁, λ₂, λ₀) of the light detected by the light receiver (220) are in the infrared or red range, in the green range and/or in the blue range.

10. The classification method according to claim 9, characterized in that
the light with the first characteristic wavelength, (λ₁), is used for continuous detection of particles by means of the particle detection unit (200), wherein particles present in the detection region (DB) are detected based on a change of their light intensity signals (I₀),
the light with the second characteristic wavelength (λ₂), and with the characteristic reference wavelength (λ₀), is used to classify the detected particles, wherein the light intensity of the light with the characteristic reference wavelength (λ₀) detected by the light receiver (220) is determined as a reference light intensity signal (I₀), and the light intensity of the light with the first characteristic wavelength (λ₁), and the second characteristic wavelength (λ₂), detected by the light receiver (220) is determined as a first and second light intensity signal (I₁, I₂) and is related to the light intensity signal (I₀) of the light with the characteristic reference wavelength (λ₁), determined by the light receiver (220), in relation.

11. The classification method according to claim 1, characterized in that
the method is stored as programming on a memory element (231) of a control module (230) of the particle detection unit (200), wherein the control module (230) is connected to the light transmitter (210) in a signal-transmitting manner in order to control the latter to emit light, and is connected to the light receiver (220) in a signal-transmitting manner in order to receive the light intensity signals (I₁, I₂, I₀) detected by the light receiver (220).

12. A particle detection unit (200) with a light transmitter (210) for emitting light along a light path (110, 111) and a light receiver (220) for detecting at least a portion of the emitted light within an incidence region (120, 121), as well as a control module (230) connected to the light transmitter (210) and the light receiver (220) for signal transmission, wherein the light transmitter (210) and the light receiver (220) are oriented with one another to define a detection region (DB), and the control module (230) is configured to detect particles located in the detection region (DB) based on the light detected by the light receiver (220), characterized in that
the light transmitter (210) has at least a first light source (241) configured to emit light of a first characteristic wavelength (λ₁), and a second light source (242) configured to emit light of a second characteristic wavelength (λ₂), as well as a reference light source (240) configured to emit light of a characteristic reference wavelength (λ₀), and/or
the light receiver (220) comprises at least a first light sensor (251) configured to detect light of a first characteristic wavelength (λ₁), and a second light sensor (252) configured to detect light of a second characteristic wavelength (λ₂), as well as a reference light sensor (250) configured to detect light of a characteristic reference wavelength (λ₀), wherein
the first and second light sources (241, 242) and the reference light source (240) of the light transmitter (210) are oriented with one another in such a way that the light emitted in each case at least partially superimposes one another, defining a common light path (110) along the optical axis (211) of the light transmitter (210), and/or
the first and second light sensors (251, 252) and the reference light sensor (250) of the light receiver (220) are oriented with each other in such a way that the light detectable by the respective light sensor (250, 251, 252) at least partially superimposes each other, defining a common region of incidence (120) along the optical axis (221) of the light receiver (220), and wherein
to define the detection region (DB) the region of incidence (121) or common region of incidence (120) of the light receiver (220) is oriented with the common light path (110) of the light transmitter (210) or the light path (111) or common light path (110) of the light transmitter (210) is oriented with the common region of incidence (120) of the light receiver (220).

13. The particle detection unit (200) according to claim 12, characterized in that
the light sources (240, 241, 242) and/or the light sensors (250, 251, 252) are configured by respective associated filters for emitting or detecting light of a respective characteristic wavelength (λ₁, λ₂, λ₀).

14. The particle detection unit (200) according to claim 12, characterized in that
the light transmitter (210) is designed as a light-emitting diode and the light receiver (220) as a photodiode, wherein the light transmitter (210) comprises at least a first LED chip (241), a second LED chip (242) and a reference LED chip (240) and/or the light receiver (220) comprises at least a first photo chip (251), a second photo chip (252) and a reference photo chip (250).

15. The particle detection unit (200) according to claim 14, characterized in that
the first and second LED chips (241, 242) and the reference LED chip (243) are arranged directly adjacent to one another on a common base plate (203) and the light emitted by each of them is oriented and/or bundled along a common optical axis (211) by means of an optical means (204).

16. The particle detection unit (200) according to claim 14, characterized in that
the first and second photo chips (251, 252) and the reference photo chip (250) are arranged directly adjacent to one another on a common base plate (203) and their respective region of incidencer is orientend and/or bundled by an optical means (204) along a common optical axis (221).

17. The particle detection unit (200) according to claim 15, characterized in that
the light sources (240, 241, 242) of the light transmitter (210) each enclose the same scattered light angle (α) with the light receiver (220) and are each oriented with the incidence region (120, 121) of the light receiver (220) to define a single, identical detection region (DB).

18. The particle detection unit (200) according to claim 16, characterized in that
the light sensors (250, 251, 252) of the light receiver (220) each enclose the same scattered light angle (α) with the light transmitter (210) and are each oriented with the light path (110, 111) of the light transmitter (210) to define a single, identical detection region (DB).

19. (canceled)

20. The particle detection unit (200) according to claim 12, characterized in that
the particle detection unit (200) is a component of an aspirating particle detection system (300) with at least one pipe and/or hose line (310) which opens into one or more monitoring regions via one or more suction openings (320) for the respective removal of a fluid sample, wherein the light transmitter (210) and the light receiver (220) are oriented with one another to define a detection region (DB) within a flow path (330) through which the fluid samples can flow.
